(19) United States
(12) Patent Application Publication
(10) Pub. No.: US 2009/0198496 A1
(43) Pub. Date: Aug. 6, 2009

(54) Aspect oriented programmable dialogue manager and apparatus operated thereby

(76) Inventor: Matthias Denecke, Astoria, NY (US)

Correspondence Address: JORDAN AND HAMBURG LLP, 122 EAST 42ND STREET, SUITE 4000, NEW YORK, NY, 10168, US

(21) Appl. No.: 12/322,411

(22) Filed: Feb. 2, 2009

Related U.S. Application Data
(60) Provisional application No. 61/063,164, filed on Jan. 31, 2008.

(51) Int. Cl. G10L 15/18

(52) U.S. Cl. 704/257; 704/E15.004

(57) ABSTRACT

A dialogue system enabling a natural language interaction between a user and a machine having a script interpreter capable of executing dialogue specifications formed according to the rules of an aspect oriented programming language. The script interpreter further contains an advice executor which operates in a weaver type fashion using an appropriately defined select function to determine at most one advice to be executed at join points identified by pointcuts.

### BACKGROUND INFORMATION

A dialogue system having a dialogue management module is disclosed. The dialogue management module includes a script interpreter for interpreting an aspect oriented programming (AOP) language. The script interpreter interacts with a point cut identifier and an advice executor responsible for selecting and executing advice. The advice selection can optionally be performed by providing an application specific selection function.

### DISCUSSION OF PRIOR ART

A software system called Dialogue System enabling spoken or written interaction between a human and a computer needs to carry out several processing steps. Generally, a dialogue system contains the components described briefly as follows. A speech recognition system captures the users' speech, converts it to text and, together with confidence information, forwards it to a natural language understanding system. A natural language understanding system extracts a representation of the meaning (semantic representation) of the recognized text. A dialogue manager that updates its internal state based on the semantic representation then decides a particular action to take place. A natural language generation system generates natural language text based on the output of the dialogue manager. A text-to-speech system converts the generated text into a sound signal, to be heard by the user.

A dialogue manager is the implementation of a complex process that is controlled by application-specific information as well as general information. For example, a simple generic confirmation strategy would be to confirm all information provided by the user that has a confidence value below a certain threshold. In this case, the confirmation strategy itself is generic as it decides whether to confirm or not based on the confidence information only. At the same time, the specific phrasing of the confirmation question is application specific as the choice of words depends on the topic of the application.

In order to reduce the burden of building dialogue systems, it is desirable to separate the specifications in such a way that application specific parts can be easily exchanged. Up until now, this is done by providing generic dialogue algorithms that interpret application specific information to decide which action the dialogue manager should take.

For example, an information-based approach is proposed in Denecke and Waibel 1997 “Dialogue Strategies Guiding Users to their Communicative Goals”, published in Proceedings of Eurospeech-97, Rhodes, Greece, 1997, pp. 1339-1342. The proposed algorithm retrieves objects from a database that match the information provided by the user. If multiple matching objects have been retrieved, the dialogue manager needs to generate a sequence of clarification questions. At each point, the dialogue manager chooses to ask questions that can be expected to provide the missing information most efficiently. In this example, the dialogue algorithm is generic. The dialogue algorithm is provided the application specific phrasing of the clarification questions.

Another example is the VoiceXML standard put forward by the W3C Committee. The VoiceXML standard contains a generic dialogue algorithm called the Form Interpretation Algorithm (FIM). The purpose of this algorithm is to play prompts to the user with the intent to acquire information. Based on the information—or the lack thereof—provided by the user the FIA moves to the next action in a predefined way. An application developer wishing to employ the FIA needs to provide application specific content in form of VoiceXML markup. While it is possible to change the application specific content, it is never possible to alter the dialogue algorithm itself in cases where it is not appropriate.

Yet another approach is object-oriented dialogue management, such as described in U.S. Pat. Nos. 5,694,558 and 6,044,347. Here, relevant information pertaining dialogue management is encapsulated in objects such as those used in object oriented programming languages. The dialogue motivators disclosed in U.S. Pat. No. 7,139,717 are an improvement in that control over the objects is guided by rules. Object oriented dialogue management has the advantage that is encapsulates methods for local dialogue management decisions in reusable objects. However, the drawback of these approaches is that it is not possible to express global dialogue strategies in a reusable manner. In order to do so, it would be necessary to specify behavior that influences multiple objects. The usefulness of such global dialogue strategies is exemplified in the paper by Fiedler and Tsovaltzi Automating Hinting in Mathematical Tutorial Dialogue, 10th Conference of the European Chapter of the Association for Computational Linguistics—Proceedings of the Workshop on Dialogue Systems: interaction, adaptation and styles of management, pp. 45-52, Budapest, Hungary, 2003. Therein, the authors illustrate how a tutorial dialogue system can generate hints according to a teaching strategy.

Incidentally, the same problem arises in the area of object oriented programming (OOP). It is not possible, for example, to express a global debugging strategy for an object oriented program in a modular fashion. To address this problem, aspect-oriented programming languages have been disclosed in U.S. Pat. No. 6,467,086. The idea is that a standard object oriented program written in a language such as Java can be augmented by advice. Advice is code that is executed under certain condition at certain points of execution called join points. An example is a debug advice that prints all parameters whenever a method is called.

However, aspect-oriented programming exhibits problems of its own as pointed out in Stoerzer 2004 (Constantinos Constantinides, Therapon Scotinides, Maximilian Störzer AOP considered harmful. Position statement for panel, accepted at EIWAS 2004, Berlin, Germany, September 2004). The first problem described there is relevant for applying AOP to dialogue management. The problem is that the OOP program is oblivious to advice application. This means that it is not possible for a method in the original OOP program to determine whether and how it has been advised. Consequently, any join point could be advised by 0, one, or multiple pieces of advice.

Furthermore, as discussed in Stoerzer 2006 Maximilian Stoerzer, Florian Forster, Robin Sterr: Detecting Precedence-Related Advice Interference. Accepted at ASE 2006, Tokyo, Japan, 2006. f, “ . . . in the absence of explicit user-defined aspect ordering advice precedence for two pieces of advice can be undefined.” This results from the fact that at any given join point multiple pieces of advice can be applicable. By the very design of AOP languages, the existence of advice is hidden from the developer of the advised code, therefore, that developer has no control over the selection, ordering and execution of advice.

The characteristics described above are problematic for dialogue management as it could result in undefined or overspecified behavior as explained below.

### SUMMARY OF THE INVENTION

The present invention is concerned with specifications as are used for describing a dialogue manager's behavior and may be embodied in the method described herein as well as machines configured to employ the method, and computer readable storage mediums contain implementations of the method in executable form. What is needed in the art is a method of specifying reusable dialogue guiding principles and application-specific content separately. Deficiencies in the prior art are due to the fact that reusable dialogue guiding principles cannot be altered by application developers. The present invention addresses the deficiencies in the prior art by providing (i) a means to specify reusable dialogue guiding principles, (ii) a means to specify application specific content and (iii) a means to combine (i) and (ii) at runtime. It does so by a modification of Aspect-Oriented Programming principles to make it suitable for dialogue management.

Briefly stated, the present invention provides a dialogue system enabling a natural language interaction between a user and a machine having a script interpreter capable of executing dialogue specifications formed according to the rules of an aspect oriented programming language. The script interpreter further contains an advice executor which operates in a weaver type fashion using an appropriately defined select function to determine at most one advice to be executed at join points identified by pointcuts.

An embodiment of the present invention provides a dialogue driven system enabling a natural language interaction between a user and the system, comprising an input component accepting input sequences of words, an output component producing output sequences of words, and a dialogue manager unit. The dialogue manager unit includes: a memory capable of storing at least one dialogue specification formed according to a dialogue specification language, the dialogue specification including a multitude of statements, the statements including standard statements, point cut statements and advice components; an execution memory storing a current execution state; and a statement interpreter configured to interpret the statements of the dialogue specification to process the input sequences of words and produce output to drive the output component to produce the output sequences of words. The statement interpreter includes a predetermined point recognizer configured to identify predetermined points during execution of the statements of the dialogue specification whereat execution of the advice components is to be considered. Further included in the dialogue manager unit is a point cut identifier configured to evaluate the point cut statements, in response to the predetermined point identifier identifying one of the predetermined points, and identify the point cut statements which return true evaluations. Further still, the dialogue manager includes an advice executer configured to select one of the identified point cut statements which evaluates as true and execute one of the advice components which is associated with the selected one of the point cut statements.

A feature of the present invention provides that the advice components each include a point cut reference identifying one of the point cut statements so as to associate the advice components with respective ones of the point cut statements, and at least one advice statement which is executed with execution of the advice component.

A further feature of the present invention provides that the statements optionally include a select function configured to select one of the identified point cut statements, and the advice executer is configured to execute the select function to select the one of the advice components of which the at least one advice statement is executed.

Yet another feature of the present invention provides that the select function effects selection of the one of the advice components based on application specific criteria.

Still another feature of the present invention provides that the select function optionally effects selection of one of the advice components based on data indicating previously executed advice components.

A still further feature of the present invention includes the select function effecting selection of one of the advice components based on data stored in the execution memory.

The present invention also provides an embodiment wherein the advice executer is configured to select one of the advice components based on a predetermined criteria in the absence of a select function.

Another feature of the present invention includes the predetermined point recognizer being configured to identify the predetermined points based on contents of the execution memory.

The present invention may be embodied as a dialogue system as described above further including a natural language understanding component processing output of the input component and passing the output to the dialogue manager. In such a configuration the input component is optionally a speech recognizer or a web browser. Instead of a web browser any other text input device may be used.

The present invention may be also embodied as a dialogue system as described above further including a natural language generation component accepting the output of the interpreter and producing text to drive the output component. In such a configuration the output component is optionally a text to speech engine or a web browser. Instead of a web browser any other text output device may be used.

A feature of the present invention provides a dialogue system according to any of the above described embodiments further comprising a controlled object controlled by the dialogue manager based on the sequences of words, the controlled object being a mechanical device which is moves based upon output of the dialogue manager produced in accordance with the sequences of words.

Another feature of the present invention provides a dialogue system according to any of the above described embodiments further comprising a controlled object controlled by the dialogue manager, the controlled object being one of a game device, an entertainment device, a navigation device, or an instructional device wherein output via the output component is a product of the controlled object. In such a configuration the controlled object optionally includes a display producing a displayed output indicative of one of a game state, an entertainment selection, a geographic location, or an informative graphic.

A still further feature of the present invention provides a dialogue system according to any of the above described embodiments further comprising a controlled object controlled by the dialogue manager, the controlled object being a database including data representative of at least one of products or services offered by a business, and the database being altered by the dialogue manager in response to the sequences of words so as to facilitate at least one of product delivery or service provision.

Yet another further feature of the present invention provides a dialogue system according to any of the above described embodiments further comprising a controlled object controlled by the dialogue manager, the controlled object being a communication device, the communication device effecting a communication link based upon output of the dialogue manager produced in accordance with the sequences of words.

As a further feature of the present invention the above describe embodiments optionally include the standard statements being configured to form a generic dialogue strategy which is absent application specific content and embodies reusable dialogue guiding principles, the advice components including advice statements embodying application specific content, and the advice executer executing the advice statements to tailor the generic dialogue strategy to a specific application.

The above, and other objects, features and advantages of the present invention will become apparent from the following description read in conjunction with the accompanying drawings, in which like reference numerals designate the same elements. The present invention is considered to include all functional combinations of the above described features and is not limited to the particular structural embodiments shown in the figures as examples. The scope and spirit of the present invention is considered to include modifications as may be made by those skilled in the art having the benefit of the present disclosure which substitute, for elements or processes presented in the claims, devices or structures or processes upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself. Still further it is understood that recitation of the preface of “a” or “an” before an element of a claim does not limit the claim to a singular presence of the element and the recitation may include a plurality of the element unless the claim is expressly limited otherwise. Yet further it will be understood that recitations in the claims which do not include “means for” or “steps for” language are not to be considered limited to equivalents of specific embodiments described herein.

### BRIEF DESCRIPTION OF THE DRAWINGS

The foregoing advantages of the present invention will be apparent from the following detailed description of several embodiments of the invention with reference to the corresponding accompanying drawings, in which:

FIG. 1 is a block diagram of a general architecture of a dialogue system embodying the present invention;

FIG. 2a is a block diagram of a dialogue manager of an embodiment of the present invention which is used in the dialogue system of FIG. 1;

FIG. 2b is a block diagram of a dialogue specification memory an embodiment of the present invention which is used in the dialogue system of FIG. 1;

FIG. 3 is a representation of a special statement structure of the present invention; and

FIG. 4 is a flow chart of a statement evaluation method of the present invention.

### DETAILED DESCRIPTION

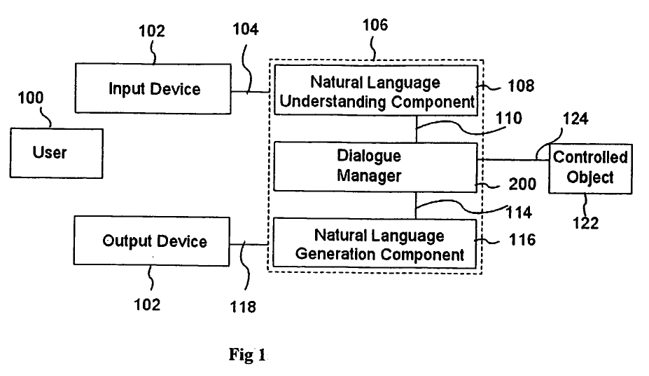

Referring to FIG. 1, an embodiment of a general architecture of a dialogue system of the present invention is illustrated. In this embodiment, an input device 102 captures information from a user 100 and transmits it to a dialogue system 106 via an information channel 104. The information channel may be realized as a telephone network, the Internet, a local area network, a wireless network, a satellite communications network, or a procedure call. The specific kind of network is not relevant to the present invention except that in this configuration, an input device will transmit information to the dialogue system.

The input device 102 includes known means, such as a microphone 108 and other processing technology (not shown) for receiving and processing a voice of a user 110. The input device 102 may be a telephone, cell phone, desktop computer, handheld computer device, satellite communication device, or any other device that can be used to receive user voice input.

The input device 102 will process the speech signals and transmit them over the network 104 to the dialogue system 106. In the preferred embodiment the input device 102 functions as a speech recognizer which converts speech to text which is transmitted over the network 104. It will be understood by those skilled in the art that a network is not needed to practice the current invention and that any channel of communication my be utilized regardless of whether it is internal to a given system or external. The dialogue system 106 may be a computer server, such as a IBM compatible computer having a Pentium 4 processor or a Linux-based system, and operate on any known operating system for running the spoken dialog program software. The sequence of words is interpreted by a natural language parser as is usual in the art and is represented in the figure as natural language understanding component 108. An example of such a parser is described in Ward 1994 (Ward, Wayne (1994): “Extracting information in spontaneous speech”, In ICSLP-1994, 83-86.) which is hereby incorporated by reference for its teachings regarding applications of such natural language parsers.

The controlled object 122 is any object that can be caused programmatically to change state or whose state changes can be observed programmatically. Examples include robots, consumer electronics devices such as TVs, cell phones, or car navigation devices wherein the state of operation of the device is changed and set via the dialogue manager responding to spoken or text input. A further example is databases bases in general wherein data may be stored via voice or text entry negotiated by the dialogue manager. These databases may be ones used by business effect any number of activities including ordering and purchasing a product, shipping product to a destination, reserving and/or transferring an article at/to a location for future use by a user including any such item from a seat at an establishment, for example a restaurant or theater, to an automobile to be rented at a location. Another application is a Computer Assisted Language Learning or Interactive Tutoring System wherein the dialogue manager controls the controlled object 122 in the form of a computer and display implementing the Computer Assisted Language Learning or Interactive Tutoring System such that lessons are presented, tests are given, and answers are evaluated to determine further lessons. Still another application is an Interactive Electronic Technical Manual which provides via the controlled object 122 in the form of a display and or audio output of the output device 102 a context-dependent repair or maintenance instructions based on input from a user processed by the dialogue system 106 of the present invention. Yet another application is a virtual agent in a game or infotainment application wherein the controlled object 122 is a game or entertainment interface, for example a computer and display, and the input processed by the dialogue system 106 of the present invention, and the game or entertainment is presented in accordance with the input processed. Further examples are web services, Object Request Brokers, and others.

While the above embodiment is applied to speech recognition systems, the present invention is also applicable to systems wherein a user inputs text. As will be appreciated by those skilled in the art, direct text input will obviate the need for the above referenced speech recognizer.

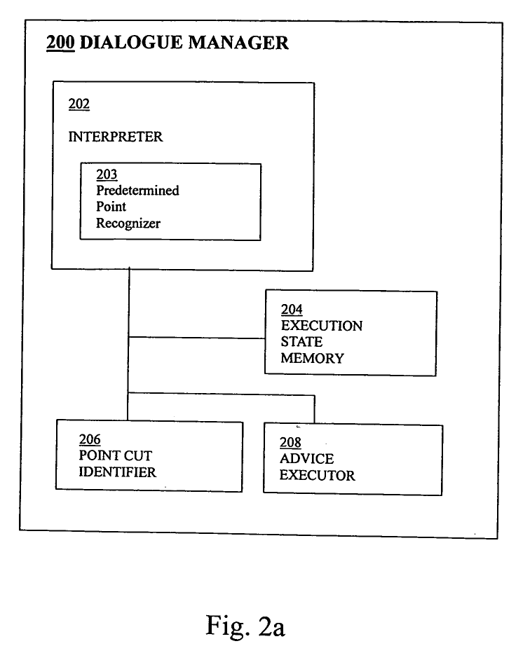

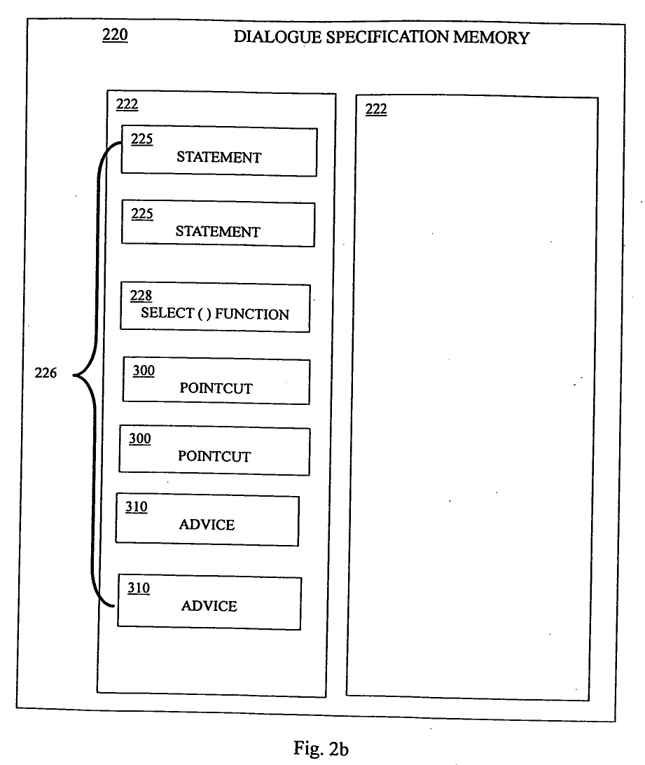

Referring to FIGS. 1, 2a and 2b, a dialogue manager 200 receives input from the natural language understanding component. The dialogue manager 200 contains an interpreter 202. The purpose of the interpreter 202 is to interpret a dialogue specification language, such as a scripting language or byte code. The particulars of the dialogue specification language are irrelevant for the present invention with exception of the requirement that a program in the formal language is to contain a sequence of statements further discussed below. The interpreter 202 accesses a execution state memory 204 holding information on a current execution state as is necessary for the appropriate interpretation of a dialogue specification 222. The execution state memory 204 may contain, for example, a state of a program counter referring to the currently executed statement. Other parameters regarding execution state may include a function call stack or any other state information that is used in the art for the interpretation of programming languages. Those skilled in the art will appreciate that the execution state memories in general are understood to include various parameters or variables hence further discussion herein is omitted.

The interpreter 202 accesses a dialogue specification memory 220 wherein one or multiple dialogue specifications 222 maybe stored. The dialogue specification 222 of the present invention is an enhanced dialogue specification which is described below. It will be understood that dialogue specifications, as used in this disclosure, may be specifications that can function independent of other specifications or may be specifications that function interdependent upon other specifications. For simplicity of disclosure, one dialogue specification 222 will be referred to herein but it is understood that the present invention will also function using multiple interdependent dialogue specifications.

The dialogue specification 220 contains a sequence of statements 226. The statements 226 include standard statements 225 of the dialogue specification language and two special types of statements not part of the dialogue specification language. The special types of statements are a point cut 300 and an advice 310 which are discussed further below. The dialogue specification 220 of the present invention will include multiple point cuts 300 and advices 310. Additionally provided is at least one select( ) function 228 which operates to select a particular one of the point cuts 300 as elaborated upon below. The definition of statements is recursive. Any advice statement 314 may be a standard statement 225. There follows below a definition of statements in an exemplary embodiment which shows how different kinds of statements interrelate.

The interpreter 202 also accesses a point cut identifier 206 functionality. At predetermined points during the interpretation of the dialogue specification 222, the interpreter 202 accesses the point cut identifier 206 that obtains a list of point cuts 300, as described below, wherein each of the point cuts 300 in the list include a condition which evaluates to true as further explained below. Evaluation of the point cuts 300 as being true identifies the predetermined point in question as being a join point. How this functionality is implemented (for example, as a memory holding an explicit enumeration of the program states or as a function determining algorithmically whether a join point has been reached) is unimportant for the present invention. In the preferred embodiment described herein, the predefined points are before and after a function call. However, it will be appreciated by those skilled in the art that other criteria may be used to identify predetermined points in the execution of the dialogue specification 222 that will result in evaluation of point cuts. U.S. Pat. No. 6,467,086 is hereby incorporated by reference for its teachings regarding join points which provides a more general basis for identifying join points rendering predetermined points utilized by the preferred embodiment discussed herein as a subset of those discussed in U.S. Pat. No. 6,467,086.

The interpreter 202 further accesses an advice executor 208. The advice executor 208 is considered to be a form of what is known in the art as a “weaver” but is not considered to be required to conform to strict definitions as may presently be applied to the term “weaver.” It suffices for the advice executor 208 to function as described herein so as to conform to the scope and spirit of the present invention.

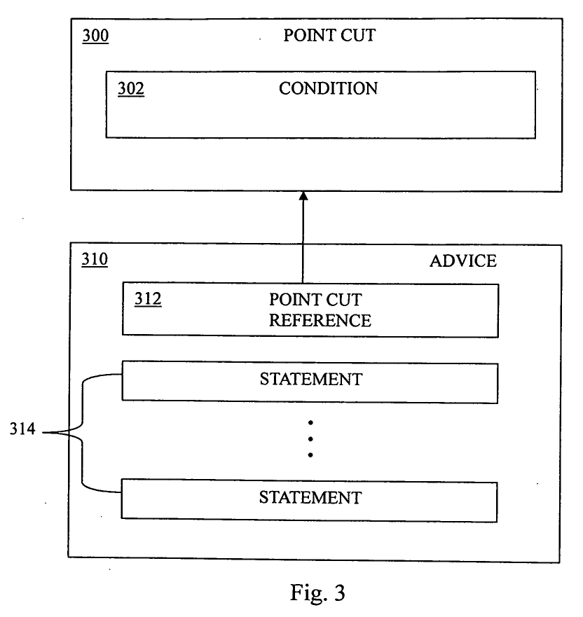

The dialogue specification language is taken together with the two special statements to form an enhanced dialogue specification language. FIG. 3 shows the structure of the special statements. The first special statement is referred to herein as the point cut 300 which is discussed above in relation to its use in identifying join points. Each point cut 300 contains a condition 302 that is an expression statement of the dialogue specification language that evaluates to true or false. Multiple point cuts 300 are optionally included in the dialogue specification 222

The second special statement is referred to herein the advice 310 of which a plurality is included in the dialogue specification 222. Each advice 310 contains a point cut reference 312 to one of the point cut 300 and a sequence of statements 314 of the dialogue specification language. The allowed statements in the sequence 314 are identical to allowed statements in a function body. The enhancement of the dialogue language is similar to the way the Aspect Oriented programming language AspectJ extends the programming language Java.

The interpretation of the enhanced dialogue specification language is defined in terms of the interpretation of the dialogue specification language. During operation, the interpreter interprets dialogue specifications 222 according to the semantics of the dialogue specification language. How the interpretation of the dialogue specification 222 executes is unimportant for the present invention and can be done according to methods known in the art. It is assumed, however, that the interpretation of the dialogue specification 222 will rely on the interpretation of the statements.

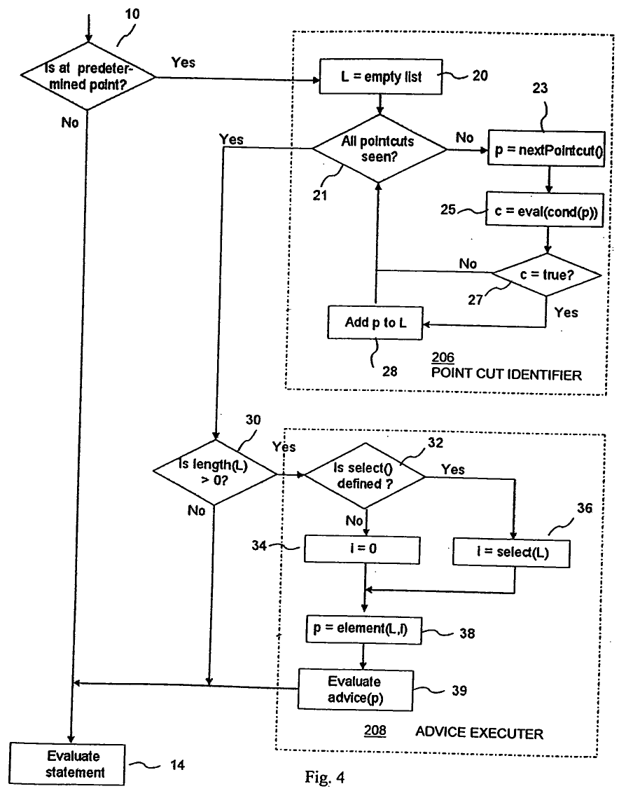

Referring to FIG. 4, a flow chart illustrates interpretation of the enhanced dialogue specification 222 used in the present invention. Before each interpretation of a statement 226, a predetermined point identifier 203 capability of the interpreter determines whether one of the predefined points in the execution has been reached at step 10. As noted above, this determination in the preferred embodiment is based on determining whether the execution state as identified by the execution state memory 204 is before or after a function call. Other criteria may be used to make this determination as is necessitated by the particular application. For example, U.S. Pat. No. 6,467,086 sets forth various criteria that are used to identify concrete points, i.e., predetermined points, in the computation which may be used in further embodiments of the present invention and for which U.S. Pat. No. 6,467,086 is incorporated herein by reference.

If at step 10 the evaluation is positive, the interpreter 202 passes control to the point cut identifier 206 which returns a list of point cuts 300. This list may possibly be empty and such a occurrence is addressed below. At step 20 a list variable L is set to an empty list. The point cut identifier 206 examines in step 21 whether all point cuts 300 defined in all the dialogue specifications 222 being utilized have been evaluated. If it is determined that some of the point cuts 300 have yet to be evaluated, the process proceeds to step 23. In step 23 the next not previously evaluated one of the point cuts 300 is assigned to variable p. The condition 302 of the particular one of the point cuts 300 assigned to p is evaluated in step 25. In step 27, it is determined if the result of step 25 equals true 27, and if so the point cut 300 assigned to p is added to the list L in step 28. Statements 23, 25, 27 and 28 are repeated for each of the point cuts 300 defined in the dialogue specification 222. It will be appreciated by those skilled in the art that many modifications the process described herein for the point cut identifier 206 may be made which alter the process in a manner that may result in faster execution or otherwise change the process. Such modifications are considered to be within the scope and spirit of the present invention when they accomplish the function required herein, i.e., assignment of ones of the point cuts 300 that evaluate to true to a list equivalent to L.

Step 30 is next executed wherein the list L of point cuts is examined and if it is determined that the list L is not empty, execution is then passed to the advice executor 208. At step 32 it is determined whether a select( ) function is part of the dialogue specification 222. The present invention includes providing the programmer with the capability to define the select( ) function 228 which operates to select one point cut of the list L of the point cuts 300 that evaluated as true. The select( ) function 228 optionally operates based on criteria identifying present states of the system operation including that of the controlled object 122 and/or prior executed statements including statements that are advice statements 314. The select function aspect of the present invention will be further referred to below regarding possible embodiments.

The purpose of the select( ) function 228 is to allow application programmers to select appropriate advice depending on criteria pertinent to the particular application at hand. For purposes of discussion herein this criteria is called application specific criteria. A user-defined select( ) function is necessary in the framework provided by the disclosed invention because different applications with have differing criteria which are used to select a particular one of a plurality of the advice 310. Thus, the present invention provides for the flexibility of permitting the user to determine criteria for selecting the advice 310 used at the time of implementing the select( ) function 228. Examples for such select( ) functions follows.

An embodiment of the disclosed invention may contain two pieces of advice 310 prompting the user for the same kind of information. However, one piece of advice 3 10 is implemented in such a way that the prompt to the user is open-ended, thus leaving the user with a large choice of words. An example for such a prompt in a voice-controlled robot application could be “What do you want me to do?” The second piece of advice 310 is implemented using a much narrower prompt, for example “Do you want me to move forward or backward?” If the user replies to the first prompt by providing several pieces of information at once, obviously the interaction between user and robot will be shorter, increasing the perceived quality of the user interface. At the same time, the likelihood of the recognizer of the input device 102 correctly recognizing the user's utterance decreases as the recognition task becomes more complex. Therefore, the select( ) function 228 in this particular example may take the previous interaction between user and robot into account, selecting the more difficult advice in situations where previous recognitions were successful, but selecting the easier advice otherwise. In this case part of the application specific criteria used in the select( ) function 228 is prior recognition success rate.

Another example of select( ) function 228 would be a robot containing a temperature sensor. Depending on the temperature, the robot could open a conversation saying “It is hot today?” or “It is cold today?” The select( ) function 228 would select the appropriate piece of advice depending on the perceived temperature. Hence, application specific criteria for the select( ) function 228 optionally includes environmental parameters.

The above examples serve to explain two possible criteria that may be used for the select( ) function 228. Other envisioned examples are selecting the advice 310 to implement teaching strategies dependent on the skill set of a student in a Computer Assisted Language Learning or Interactive Tutoring System, selecting the advice 310 to give context-dependent repair or maintenance instructions in an Interactive Electronic Technical Manual, or selecting context-dependent advice 310 to express the mood of a virtual agent in a game or infotainment application. In such applications the criteria can be respectively test results, operation descriptions, or game status information representing a present state of a game or presentation. The preceding listing of examples of selection criteria is, of course, not exhaustive but merely exemplary and one skilled in the art will recognize other criteria for the selection( ) function 228 of the present invention. Use of such criteria is considered to be within the scope and spirit of the present invention and will be referred to herein as the application specific criteria.

In step 32, if no application-specific select( ) function 228 is defined, the variable i is assigned the value 0. If an application-specific select( ) function 228 is defined, step 32 calls the select( ) function 228, passing the list L as its only argument. While the list L is the only argument in the present example, the present invention is not interpreted to exclude other additional arguments in variations of the disclosed embodiment of the invention as may be realized by those skilled in the art. In step 36, the resulting index produced by the executed select( ) function 228 is stored in a variable i. In step 38, the variable p is assigned the index of the one of the point cuts 300, whose conditions 302 evaluated as true, that is selected by the select( ) function 228 based upon the application specific criteria. In step 39, the advice 310 associated with the selected one of the point cuts 300 is identified by the included point cut reference 312 and is executed (evaluated) by calling the script interpreter to execute the sequence of the statements 314 of the advice 310 associated with the point cut 228 selected by the select( ) function 228. After completion of the execution of the sequence of statements 314, control is passed back to the interpreter 200 and execution of the dialogue specification 222 continues.

Comparison with Standard Aspect Oriented Programming:

The disclosed invention does not have the two characteristics of traditional Aspect Oriented Programming languages discussed in the discussion of prior art. The first difference is that in the present invention at most one of a plurality of the advice 310 can be executed at each join point. This is a fundamental difference between the present invention and AOP which allows an application designer to specify multiple advice for one join point. This allows the application programmer to define multiple, differing pieces of advice, only one of which is selected during program execution. Hence, the dialogue specification 228 may include functionality tracking advice execution and past advice execution which is included in application specific criteria used by the select( ) function 228. The advantage is that the developer of a dialogue strategy can expect certain pieces of the developed code to be complemented by the advice 310. This allows the development of partially specified dialogue strategies. The application specific parts of the dialogue strategy are provided by advice 310 developed at a later point.

A second difference, in contrast to standard AOP, is that the present invention provides for allowing the programmer to later develop a select( ) function 228 which selects an appropriate one of the plurality of the advices 310 at runtime during program execution by means of the select( ) function 228 selecting one of the point cuts 300. This functionality allows an application designer to easily program different “characters” of the machine into the select( ) function 228. For example, if the user repeats the same information over and over, the application developer can provide two varieties of the advice 310, the first of which reacts in a friendly way, and the second which reacts in an unfriendly way. The select( ) function 228 is implemented in such a way that the first advice 310 is selected the first two times the user presents inappropriate information, and the second advice 310 is selected any other time. The resulting system will react in a friendly way to the first two inappropriate user inputs, and in an unfriendly way to the following inappropriate user inputs. Such a system could not be implemented using Aspect Oriented Programming in the way disclosed here with traditional implementations of weavers as disclosed in Kiczales 1997. This is because Standard Aspect Oriented Programming assumes advice to be invisible from the advisee and other advice.

Advice is made visible to the application programmer by allowing him to access the advice constructs from the programming language itself. For example, the list L of point cuts 300 is passed to the select( ) function 228. In the implementation of the select( ) function, the programmer can access the advice 310 associated with the point cuts 300 and select the appropriate advice 310. Therefore, in prior art Standard Aspect Oriented Programming, if at one join point multiple pieces of advice may be executed, all of them will. In contrast, the currently disclosed invention includes the advice 310 executed before a function call, or other type of predetermined point in the execution of the dialogue specification 222, being visible to the advised dialogue specification by means of the select( ) function 228 run by the advice executor 208. In order to select the most appropriate advice for the current state the system is in, the select( ) function 228 may access any data created or manipulated during a previous execution of any statement (this will include the standard statements 225 and the advice statements 314) as well as data or state information contained in the controlled object 122. Furthermore, the advice executor 208 is implemented in such a way that at most one piece of advice 310 is run at any given join point.

In a possible implementation of this aspect of the present invention, the application programmer may choose to log execution of the advice 310 by adding appropriate programming statements 314 to the advice. Alternatively, a chosen one of the point cuts 300 could also be logged in the select( ) function 228. The select( ) function 228 is any function that can be expressed in the base OOP language, therefore, the programmer may choose to add statements effecting logging to the select( ) function 228. It is considered more convenient to do the logging in the select( ) function 228 rather than the statements 314 attached to advice 310 because it would have to be done only once instead of for each advice 31 0.The statements of the chosen programming language to be enhanced with Aspect Oriented Programming allows the programmer to manipulate data in the execution state memory 204 by means of its statements in the dialogue specification 222. So, the log information could be created by any of the statements therein. Based on this disclosure, it will be appreciated by those skilled in the art that the select( ) function 228 does not require log information (or any state information) to be available. An example for a useful select( ) function 228 that does not rely on state information at all would be one that selects advice 310 randomly to avoid the user getting bored with the systems' responses. It will further be noted that the logging is not required by the present invention in that there is no requirement at all to log previously executed advice 310. If the application programmer chooses to log advice execution, he will add programming constructs in the chosen programming language (ECMAScript in the preferred embodiment) to that effect. The example of the select( ) function 228 that selects advice depending on the temperature exemplifies that context dependent advice selection is possible without logging.

A third difference, in contrast to standard AOP, is that the disclosed invention introduces the application definable select( ) function 228 which is not present in traditional AOP. The select( ) function 228 gives the application developer control over the selection of advice. The select( ) function 228 can be implemented in any way as necessary for the application in question. In particular, the select( ) function 228 may take the current execution state into account when determining the advice 310 to execute. Therefore, the disclosed invention makes it easier for the application developer to have the system react to user input in a dynamic context-dependent fashion, resulting in systems that behave in apparently smarter ways.

An exemplary embodiment of the invention is presented as follows. The dialogue manager 200 contains the script interpreter 202 in the form of one compliant with the ECMAScript specification ECMA-262-3. The script interpreter 202 is extended by the point cut identifier 206, which some may term to be a “weaver,” and a selector function in the form of the select( ) function 228. The selector function always returns 0.

The script language grammar is extended by new language constructs for pointcutStatement and aspectStatement as follows.

```
PointcutStatement ::=
    pointcut Identifier (ParameterList ) : PointcutExpression;
AdviceStatement ::=
    advice Identifier Rel Identifier (ParameterList) { FunctionBody }
Rel ::=
    before
    after
PointcutExpression ::=
    PointcutCallExpression && PointcutLogicalAndExpression
PointcutCallExpression ::=
    call ( Identifier ( ParameterList ) )
PointcutLogicalAndExpression ::=
    PointcutRelationalExpression
    PointcutLogicalAndExpression && PointcutRelationalExpression
PointcutRelationalExpression::=
    PointcutPrimaryExpression == PointcutPrimaryExpression
    PointcutPrimaryExpression < PointcutPrimaryExpression
    PointcutPrimaryExpression > PointcutPrimaryExpression
    PointcutPrimaryExpression <= PointcutPrimaryExpression
    PointcutPrimaryExpression >= PointcutPrimaryExpression
    PointCutPrimaryExpression instanceof PointcutPrimaryExpression
    PointCutPrimartExpression in PointcutPrimaryExpression
PointcutPrimaryExpression ::=
    IdentifierName
    ObjectLiteral
    ArrayLiteral
    Literal
```

Productions not found here (such as Identifier or FunctionBody) can be found in ECMA 262-3.

The execution state contains the function call stack, an argument object containing references to the variables passed as arguments to the current function, a reference to either the global object, or if the currently executed function is attached to an object, a reference to this object. The execution state of the preferred embodiment is implemented according to Chapter 10 of E262-3.

The possible join points of an aspect-oriented programming language define when the code associated with the advice 310 can be executed. In the preferred embodiment, join points are limited to before and after function calls. Other AOP languages, such as the one disclosed in Kiczales 2002 (A semantics for advice and dynamic join points in aspect-oriented programming, by Gregor Kiczales, Christopher Dutchyn, ACM Transactions on Programming Languages and Systems 2002) allow a richer join point model, thus allowing advice to be run at different places during program execution. However, in the preferred embodiment of the disclosed invention, a richer join point model is not necessary. Nonetheless, the scope and spirit of the present invention does not prohibit a richer join point model unless specifically dictated by the claims.

Operation of an exemplary embodiment of the present invention proceeds as follows. The standard interpretation of a programming statement in the chosen script language is replaced by the interpretation shown in the flow diagram in FIG. 4. Before each statement is interpreted, in step 10, the script interpreter determines whether the current program state is at a point cut by means of the predetermined point recognizer 203 functioning. If it is the case that such point is reached, the point cut identifier 206 is called. Then, the statement interpretation continues as it would in the standard script language.

The point cut identifier 206, when called, executes the dialogue specification 222 as follows. First, it executes all point cuts 300 and determines those point cuts evaluating to true via steps 21, 23, 25, 27 and 28. If no point cuts have a condition 302 that evaluate as true, it returns control flow to the caller via decision step 30. If a select( ) function 228 is provided in the dialogue specification, the advice executor 208 accepts an array in the form the list L containing references to all point cuts 300 evaluating to true, and calls the select( ) function 228 passing the array as an argument. If the select( ) function 228 returns a valid reference to one of the point cuts 300 passed, the advice executor 208 calls the script interpreter recursively to execute the advice 310 associated with that point cut 300. In all other cases, the advice executor 208 calls the script interpreter to execute the advice associated with some predetermined one of the point cuts 300 identified in the list L, for example, the first in the list L.

The following example illustrates the operation of the present invention as embodiment in the form of a voice controlled robot as the controlled object 122. A voice operated robot has the ability to move forward and backward at different speeds. The parts of the dialogue specification 222 relevant to the disclosed invention are given in script 1 and 2 below. Script 1 encodes a reusable dialogue strategy.

```
function seekInformation(dlgState,prompt) {
  if (prompt != “”) {
    ... render prompt ...
    return true;
  } else {
    return false;
  }
}function endDialogue(dlgState,prompt) {
  if (prompt != “”) {
    ... render prompt ...
    return true;
  } else {
    return false;
  }
}function dialogue(sem) {
  updateSemanticRepresentation(dlgState,sem);
  if (endDialogue(dlgState,pr) ) {
    ... perform functionality to end the dialogue
  } else if (seekInformation(dlgState,t)) {
    ... perform functionality to end the dialogue
  }
}
```

Script 1: Sketch of a generic dialogue script

Script 2 encodes point cuts and advice for the robot application. The advice prompts for speed, direction or speed and direction of the robot, or executes the desired movement.

```
      /*
      * The following pointcuts define conditions for the
advice below
      */
  pointcut CanPromptDirection(sem,p) :
        call(seekInformation(dlgState,t) )  && !(“dir” in sem);
  pointcut CanPromptSpeed(sem,p) :
        call(seekInformation(sem,p) )  && !(“speed” in sem);
  pointcut CanPromptSpeedAndDirection(sem,p) :
        call(seekInformation(sem,t) ) && !(“dir” in sem)
        && !(“speed” in sem);
  pointcut CanExecuteMovement(s,t) :
        call(endDialogue(sem,t) )  && (“dir” in sem)
        && (“speed” in sem);
  /*
      */
  advice PromptDirection before CanPromptDirection(s,p) {
      p  = “Would you like me to move forward or
  backward??”;
    }
    advice PromptSpeed before CanPromptSpeed(s,p) {
      p  = “How fast would you like me to move?”;
    }
    advice PromptSpeedAndDirection before
              CanPromptSpeedAndDirection (s,p) {
      p  = “Would you like me to move forward or backward,
              and at what speed?”;
    }
    advice ExecuteMovement before CanExecuteMovement(s,p) {
      p  = “I am moving.”;
      robot.move(s.dir,s.speed);
    }
```

Script 2: Pointcuts and advice

In the following, ‘User’ refers to natural language user input, provided, for example through a speech recognition engine, ‘System’ refers to natural language output, rendered, for example through a Text-to-speech system. Furthermore, L refers to the point cut list L as determined by the algorithm whose flow chart is shown in FIG. 4.

### Step 1:

| | |
|---|---|
| User: | Please move |
| SR: | [action = ‘move’] |
| L: | PromptDirection, PromptSpeed, PromptSpeedAndDirection |
| select( ): | 0 |
| System: | Would you like me to move forward or backward? |

### Step 2:

| | |
|---|---|
| User: | Move forward |
| SR: | [action = ‘move’, dir = ‘forward’] |
| L: | PromptSpeed |
| select( ): | 0 |
| System: | How fast would you like me to move? |

### Step 3:

| | |
|---|---|
| User: | Move fast |
| SR: | [action = ‘move’, dir = ‘forward’, |
| | speed = ‘fast’ ] |
| L: | ExecuteMovement |
| select( ): | 0 |
| System: | I am moving forward. |

In this example, the join points are seekInformation( ) identified by pointcuts CanPromptDirection, CanPromptSpeed, CanPromptSpeedAndDirection, and endDialogue( ), identified by pointcut CanExecuteMovement. Whenever the script interpreter reaches a join point, a list of pointcuts evaluating to true is determined.

In step 1, the natural language understanding component 108 analyses the input, generates a semantic representation of the input and passes it on to the dialogue manager 200. The dialogue manager 200 executes the dialogue specification script according to the algorithm shown in FIG. 5. After calling the function updateSemanticRepresentations( ) which is not advised, the script interpreter calls the function endDialog( ). At this point, the speed and dir variables are undefined in the semantic representation.

The current execution state is a join point as decided in step 10, so the script interpreter 202 needs to determine a list of valid point cuts 300. The interpreter 202 sets the variable L to the empty list in step 20. Using the function nextpointcut( ) for step 23, the interpreter 202 assigns the pointcut CanPromptDirection( ) to the variable p. Using the function cond(p), the interpreter 202 retrieves the condition 302 for the point cut 300, evaluates it and stores the result in variable c in step 25. If c equals true in step 26, the pointcut p is added to the list L in step 28. In this case, the condition for CanPromptDirection evaluates to true, so the point cut 300 is added to the list L. Only one out of the four pointcuts have been inspected at step 21, so the loop continues by retrieving the next point cut 300 in step 23. The same procedure is applied to all point cuts 300.

Once all four pointcuts 300 have been inspected, the interpreter 202 determines whether the condition 302 of any of the pointcuts 300 evaluates to true in step 30. In this case, the list L consists of the pointcuts PromptDirection, PromptSpeed, PromptSpeedAndDirection. The interpreter 202 then passes control to the advice executor 208. The select( ) function 228 is undefined in this example in step 32, so the interpreter sets the variable i to 0 in step 34 and assigns the first point cut 300 from the list L to variable p in step 38 based upon a predetermination the first point cut 300 of the list L will be used when no select( ) function 228 is defined. It is understood that any other predetermined one of the point cuts 300 may have been assigned as the predetermined one but for the sake of example the first one was assigned. Then, the advice executor 208 executes in step 39 the advice 310 associated with the first point cut 300 by the point cut reference 312 which assigns the prompt “Would you like me to move forward or backward?” to the variable p. The interpreter 202 then continues to evaluate the function call statement endDialogue( ).

The advice 310 defines the prompt variable whose value is then rendered through a text-to-speech engine by the dialogue script. The user answers the question, the user input is again analyzed by the natural language understanding component and passed on to the dialogue manager 200. The dialogue manager 200 incorporates the semantic information into its state to yield the semantic representation shown in step 2 listed above. Now, at join point endDialogue( ), the pointcut CanExecuteMovement still evaluates to false, because the variable speed is undefined. At join point seekInformation, the pointcuts CanPromptDirection and CanPromptSpeedAndDirection evaluate both to false because the direction variable is defined. The variable prompt is defined during advice execution, and its value rendered to the user. The user's answer is again analyzed by the natural language understanding unit and passed on to the dialogue manager 200. After incorporation, the combined semantic representation looks like the one shown in step 3 listed above. Now, the pointcut CanExecuteMovement evaluates to true at join point endDialogue( ) and the robot is set in motion by the advice 310 associated with the point cut 300.

To illustrate how the select( ) function 228 can be used to control the dialogue, assume a select( ) function 228 that selects the point cut CanPromptSpeedAndDirection in the first step of the above example instead of PromptDirection. Instead of asking the user “Would you like me to move forward or backward?” The system will prompt “Would you like me to move forward or backward, and at what speed?” Because this question asks for two pieces of information at the same time, the dialogue will shorten to two turns instead of three as in the example above. At the same time, because the question is less constrained, the user has more ways of answering, thus making the speech recognition process more complex and error-prone. This illustrates how the choice of the select( ) function 228 can be used to offset dialogue brevity against reliable speech recognition. Hence, the application specific criteria will include a reliability level associated with the point cuts 300.

As background information, in the following, the term dialogue strategy refers to a particular dialogue specification with characteristics that are observable by the user. For example, a dialogue strategy aiming to minimize the expected length of the dialogue will ask open-ended questions, such as “Please tell me what you want me to do”. A dialogue strategy aimed at novice users will give more background information and ask narrow questions, such as “I can move forward and backward and at different speeds. How fast would you like me to move?”.

From the description above, a number of advantages of the aspect-oriented dialogue manager 200 of the present invention become apparent:
1. Dialogue strategies, such as the one shown in script 1, can be written in an incomplete fashion, leaving out all application specific information. As a result, dialogue strategies become generic and can be reused for different applications, thus reducing the development effort for the complete dialogue specification.
2. The separation of dialogue strategies from application specific information can occur in any fashion deemed appropriate by the developer. This is due to the fact that any piece of advice 310 may contain a full script. Therefore, it is up to the developer to decide whether necessary program steps could be coded in the dialogue strategy of the standard statements 225 in the dialogue specification 222 or in the advice statements 310. This is in contrast to VoiceXML's Form Interpretation Algorithm, which has specific predefined “holes” for application specific information to be filled in.
3. The select( ) function 228 allows application developers to select advice depending on the dialogue as it unfolds up until the present. The information is saved by instructions in the dialogue specification 222. This is application dependent just like the select( ) function. The developer can write the dialogue specification 222 in such a way that for example the number of turns in a dialogue is counted. In a telephonybased system, if the number of turns exceeds a certain threshold, the caller is transferred to a human operator. The decision which advice 310 to select can be made at runtime, not at compile time. Thus, the resulting dialogue system 200 becomes capable of reacting to events unfolding during the dialogue itself. For example, in the event of unreliable speech recognition, advice 310 expected to result in better speech recognition results may be chosen.

The present invention addresses the deficiencies in the prior art by providing (i) a means to specify reusable dialogue guiding principles (RDGP), (ii) a means to specify application specific content and (iii) a means to combine (i) and (ii) at runtime. It does so by a modification of Aspect-Oriented Programming principles to make it suitable for dialogue management in a manner that will vary dependent upon the implementation. Usually, a subset of the standard statements 225 will embody an RDGP. However, it will be appreciated by those skilled in the art that this is not a hard requirement of the present invention because statements of the OOP language (ECMAScript in the preferred embodiment) and the advice 310 and point cut statements 300 interrelate, such a separation is not always possible or clear cut. For example, the application programmer may provide a function func( ) which is called both from advice and the RDGP. I such a situation the statements that make up the func( ) part are arguably part of the RDGP but do not fit a clear cut definition. To be specific, if one takes any complete dialogue specification 222 which contains a sequence of statements 226, and removes any number of point cuts 300, advice 310, or other statements, the result may be considered a RDGP. This RDGP would have to be complemented with other statements to make it a complete specification again. Some examples include:
(1) A dialogue specification 222 for a robot application in English: Remove all advice 310 that contains the English language prompts. The resulting specification is reusable in the sense that the same dialogue strategy can be complemented with equivalent prompts in another language.
2) Remove the select( ) function 228 from a dialogue specification 222. The resulting dialogue strategy is reusable in the sense that the choice of advice may be customized.

From the above it can be seen that the present invention allows dialogue application developers to separate dialogue specifications such that the separated dialogue specifications can be weaved together at runtime by the dialogue manager. In the preferred embodiment of the present invention a generic dialogue specification provides an RDGP that is free of application specific content. However, it will be appreciated that such complete division is not always praticable and for the purposes of the present disclosure, unless otherwise delineated, a generic dialogue specification will provide an RDGP that is substantially free of application specific content. The generic dialogue specification is wove together at runtime with advice components having executable advice statements 314 that provide application specific content. For the purposes of this disclosure, unless otherwise restricted, a dialogue specification will be considered a generic dialogue specification even though it accesses application specific functions which may also be accessed by advice 310.

While the above description contains many specificities, these should not be construed as limitations on the scope of the invention, but rather as an exemplification of one preferred embodiment thereof. Many other variations are possible. Accordingly, the scope of the invention should be determined not by the embodiment(s) illustrated, but by the appended claims and their legal equivalents.

While particular embodiments of the present invention have been shown and described, it will be appreciated by those skilled in the art that, based upon the teachings herein, changes and modifications may be made without departing from this invention and its broader aspects and, therefore, the appended claims are to encompass within their scope all such changes and modifications as are within the true spirit and scope of this invention. The true spirit and scope is considered to encompass devices and processes, unless specifically limited to distinguish from known subject matter, which provide equivalent functions as required for interaction with other elements of the claims and the scope is not considered limited to devices and functions currently in existence where future developments may supplant usage of currently available devices and processes yet provide the functioning required for interaction with other claim elements. Furthermore, it is to be understood that the invention is solely defined by the appended claims. It is understood by those with skill in the art that unless a specific number of an introduced claim element is recited in the claim, such claim element is not limited to a certain number. For example, introduction of a claim element using the indefinite article “a” or “an” does not limit the claim to “one” of the element. Still further, the following appended claims can contain usage of the introductory phrases “at least one” and “one or more” to introduce claim elements. Such phrases are not considered to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; similarly, the use in the claims of definite articles does not alter the above related interpretation indefinite articles such as “a” or “an”.

What is claimed is:

1. A dialogue driven system enabling a natural language interaction between a user and the system, comprising:
an input component accepting input sequences of words;
an output component producing output sequences of words; and
a dialogue manager unit including:
a memory capable of storing at least one dialogue specification formed according to a dialogue specification language, said dialogue specification including a multitude of statements, said statements including standard statements, point cut statements and advice components;
an execution memory storing a current execution state;
a statement interpreter configured to interpret said statements of the dialogue specification to process said input sequences of words and produce output to drive said output component to produce said output sequences of words;
said statement interpreter including a predetermined point recognizer configured to identify predetermined points during execution of said statements of said dialogue specification whereat execution of said advice components is to be considered;
a point cut identifier configured to evaluate said point cut statements, in response to said predetermined point identifier identifying one of said predetermined points, and identify said point cut statements which return true evaluations; and
an advice executer configured to select one of said identified point cut statements which evaluates as true and execute one of said advice components which is associated with said selected one of said point cut statements.

2. The dialogue driven system according to claim 1, wherein said advice components each include:
a point cut reference identifying one of said point cut statements so as to associate said advice components with respective ones of said point cut statements; and
at least one advice statement which is executed with execution of said advice component.

3. The dialogue driven system according to claim 2, wherein:
said statements include a select function configured to select one of said identified point cut statements; and
said advice executer is configured to execute said select function to select the one of said advice components of which said at least one advice statement is executed.

4. The dialogue driven system according to claim 3, wherein said select function effects selection of the one of said advice components based on application specific criteria.

5. The dialogue driven system according to claim 3, wherein said select function effects selection of the one of said advice components based on data indicating previously executed advice components.

6. The dialogue driven system according to claim 3, wherein said select function effects selection of the one of said advice components based on data stored in said execution memory.

7. The dialogue driven system according to claim 2, wherein said advice executer is configured to select the one of said advice components of which said at least one advice statement is executed based on a predetermined criteria.

8. The dialogue driven system according to claim 1, wherein said predetermined point recognizer is configured to identify said predetermined points based on contents of said execution memory.

9. The dialogue system of claim 1, further including a natural language understanding component processing output of said input component and passing the output to said dialogue manager.

10. The dialogue system of claim 9 wherein said input component is a speech recognizer.

11. The dialogue system of claim 9 wherein said input component is a web browser.

12. The dialogue system of claim 1, further including a natural language generation component accepting said output of said interpreter and producing text to drive said output component.

13. The dialogue system of claim 12 wherein said output component is a text to speech engine

14. The dialogue system of claim 13 wherein said output component is a web browser.

15. The dialogue system of claim 1, further comprising a controlled object controlled by said dialogue manager based on said sequences of words, said controlled object being a mechanical device which is moves based upon output of said dialogue manager produced in accordance with said sequences of words.

16. The dialogue system of claim 1, further comprising a controlled object controlled by said dialogue manager, said controlled object being one of a game device, an entertainment device, a navigation device, or an instructional device wherein output via said output component is a product of said controlled object.

17. The dialogue system of claim 16, wherein said controlled object includes a display producing a displayed output indicative of one of a game state, an entertainment selection, a geographic location, or an informative graphic.

18. The dialogue system of claim 1, further comprising a controlled object controlled by said dialogue manager, said controlled object being a database including data representative of at least one of products or services offered by a business, and said database being altered by said dialogue manager in response to said sequences of words so as to facilitate at least one of product delivery or service provision.

19. The dialogue system of claim 1, further comprising a controlled object controlled by said dialogue manager, said controlled object being a communication device, said communication device effecting a communication link based upon output of said dialogue manager produced in accordance with said sequences of words.

20. The dialogue system of claim 1, wherein:
said standard statements are configured to form a generic dialogue strategy which is absent application specific content and embodies reusable dialogue guiding principles;
said advice components includes advice statements embodying application specific content; and
said advice executer executes said advice statements to tailor said generic dialogue strategy to a specific application.
